(19) United States
(12) Patent Application Publication
(10) Pub. No.: US 2022/0389870 A1
(43) Pub. Date: Dec. 8, 2022

(54) REFRIGERATION SYSTEM FOR A GAS TURBINE

(71) Applicant: NOOTER/ERIKSEN, INC., Fenton, MO (US)

(72) Inventors: Piero Scapini, Milano (IT); Nathan Ross, Ballwin, MO (US)

(21) Appl. No.: 17/763,567

(22) PCT Filed: Sep. 25, 2020
(86) PCT No.: PCT/US2020/052765

§ 371 Date: Mar. 24, 2022

Related U.S. Application Data
(60) Provisional application No. 62/907,167, filed on Sep. 27, 2019.

(51) Int. Cl. F02C 7/14; F25B 9/00; F25B 9/06; F25B 47/00

(52) U.S. Cl. CPC F02C 7/14; F25B 9/008; F25B 9/06; F25B 47/006; F05D 2260/20

(57) ABSTRACT

A system and method are disclosed for cooling ambient air to be supplied as combustion air to a gas turbine. The system comprises a closed coolant loop direct expansion cooling system including a compressor for compressing a suitable working fluid, an expansion device downstream from the compressor for expanding the working fluid so as to cool a cooling coil. The cooling coil is in heat exchange relation with ambient air flowing to the gas turbine for lowering the temperature of the ambient air to a lower temperature such that combustion air delivered to the gas turbine is below the ambient temperature thereby to increase the efficiency of the gas turbine. A return line is provided for returning the working fluid to the compressor.

### RELATED APPLICATIONS

This application claims priority to U.S. Provisional Appl. No. 62/907,167 filed Sep. 27, 2020 which is incorporated herein by reference.

### STATEMENT REGARDING FEDERALLY SPONSORED RESEARCH

Not Applicable.

### BACKGROUND ART

This disclosure relates to a direct expansion refrigeration system and method for cooling ambient air on hot days prior to introducing such air as combustion air into the inlet of a gas turbine to increase the operating efficiency of the gas turbine. It has been known that if, on hot days the combustion air for a gas turbine is cooled, the efficiency of the gas turbine can be improved. In most cases, the gas turbine directly drives an electrical generator, and the hot exhaust from the gas turbine is used in a Heat Recovery Steam Generator (HRSG) to provide steam to a steam turbine, which in turn drives another generator for generating electricity. Reference may be made to such U.S. Patents as U.S. Pat. Nos. 6,173,563, 6,318,065, 6,457,315, 7,343,746 and 8,286,431 that describe prior art refrigeration systems for cooling inlet air for a gas turbine.

The system and method of the present disclosure differ from such prior art systems in that the incoming gas turbine inlet air is cooled by means of the direct expansion of a working fluid within a refrigeration cycle, which via a heat exchanger is in direct heat exchange relation with the inlet air and which does not rely on an intermediary chilling fluid, such as chilled water.

### SUMMARY OF THE INVENTION

A system for cooling ambient air to be supplied as combustion air to a gas turbine comprising a closed coolant loop direct expansion cooling system is disclosed. The coolant loop has a compressor for compressing a suitable working medium, and an expansion device downstream from the compressor for expanding the working fluid so as to cool a cooling coil. The cooling coil is in direct heat exchange relation with ambient air flowing to the gas turbine for lowering the temperature of the ambient air to a lower temperature such that combustion air delivered to the inlet of said gas turbine is at a temperature below the ambient temperature so as to increase the efficiency of the gas turbine. A return line returns the working fluid to the compressor.

Other object and features of the present disclosure will be in part apparent to those skilled in the art and in part pointed out hereinafter.

### BRIEF DESCRIPTION OF THE DRAWINGS

FIG. 1 is a diagram of the cooling system of the present disclosure for cooling ambient air to a desired temperature prior to the ambient air being supplied as inlet air (combustion air) to a gas turbine in which the working fluid in the cooling system being directly expanded through an expansion device, such as an expansion valve, where the working fluid passes through a heat exchanger that is in direct heat exchange relation with the incoming ambient temperature combustion air to be supplied to the gas turbine; and

FIG. 2 is a diagram of the cooling system of the present disclosure that is similar to FIG. 1 except the expansion device is a turbine powered by the expanding working fluid where this turbine may be used to power another electrical generator or to power components, such as pumps or the like, in the cooling system.

Corresponding reference characters indicate corresponding parts throughout the several views of the drawings.

### DESCRIPTION OF PREFERRED EMBODIMENTS

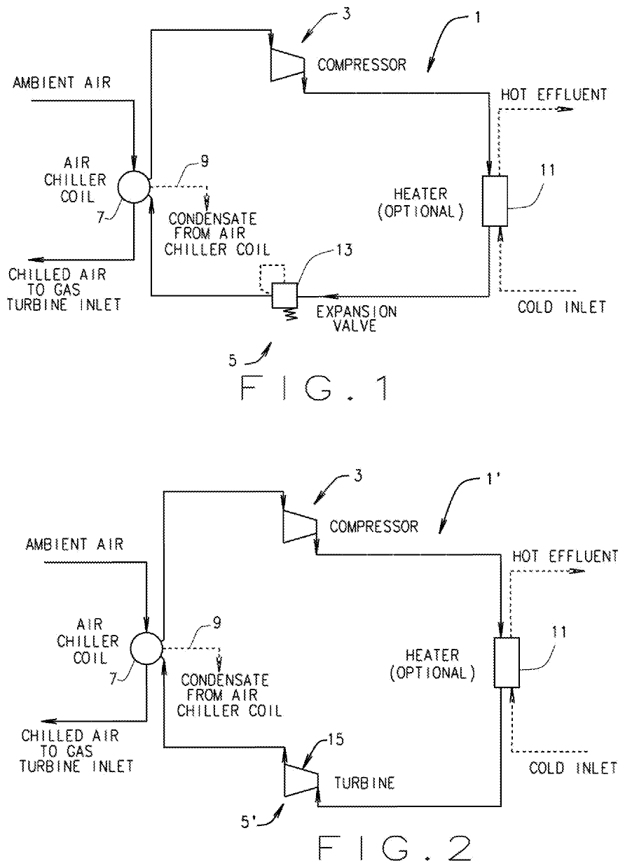

Referring now to FIG. 1, a direct expansion cooling system of the present disclosure is indicated in its entirety at 1. This cooling system cools ambient combustion air that is supplied to the inlet of a gas turbine (not shown in the drawings) of a combined power system that may, for example, use a natural gas-fired gas turbine to directly drive an electrical generator where the hot exhaust gas from the gas turbine is utilized in a Heat Recovery Steam Generator (HRSG) (not shown in the drawings), but whose construction and operation is well known to those skilled in the art. While the use of the system 1 of the present disclosure may preferably be used with such a combined cycle system using a HRSG or the like, it will be understood that the cooling system 1 may be used on a simple cycle system that does not use a HRSG.

Cooling system 1 is a closed loop refrigeration system where a suitable working fluid (as will be hereinafter described) is compressed by a compressor 3. The working fluid flows from the compressor in a hot, high temperature state in either in a gaseous or liquid form and it then flows through an expansion device 5 that allows the working fluid to expand and to cool. The cool working fluid is then passed through an air chiller 7. The air chiller is preferably a heat exchanger that is in direct heat transfer relation with ambient air that is supplied to the inlet the gas turbine (not shown) for cooling the intake or combustion air for the gas turbine under hot ambient temperature conditions. By cooling hot, ambient air, the overall efficiency of the gas turbine is increased. As the working fluid exits chiller 7, it is at a pressure level such that it may be fed to the inlet to compressor 3 so the cycle can be repeated. As indicated at 9, condensate that may form on chiller 7 may be collected and piped away from the system in a manner well-known in the art. It will be appreciated that in accord with the present disclosure, a control system (not shown) such as is well known in the refrigeration art may be employed so as to prevent the buildup of ice on cooling coil 7. As indicated at 11, an optional heater or heat exchanger may be provided between compressor 3 and expansion device 5 so that some of the heat of compression of the working fluid that is compressed in compressor 3 may be transferred for other plant processes, such as initial stage boiler feedwater heating.

As shown in FIG. 1, the expansion device 5 may be an expansion valve 13 or the like that drops the pressure of the working fluid and that cools chiller 7 so that the cold chiller may cool the incoming combustion or inlet air for the gas turbine to be cooled on a hot day to a lower temperature. This, in turn, allows the gas turbine to operate at an improved efficiency. As shown in FIG. 2, the expansion device 5′ is a gas turbine 15 driven by expansion of the working fluid flowing through the turbine. After being expanded in the turbine 15, the working fluid is piped to air chiller 7 to cool the incoming gas turbine inlet air. Turbine 15 may be used to drive an electrical generator (not shown) to generate electricity that may be used to offset at least some of the energy required to drive compressor 3 or to power other components of the system such as pumps and the like.

Those skilled in the art will recognize that by utilizing direct expansion of the working fluid, the need for an intermediate cooling system, such as a chilled water cooling coil, with its attendant piping, pumps and the like is eliminated. Because the need for a chilled water cooling system is eliminated the plant's overall water consumption if reduced. Further, condensate from the direct expansion air chiller 7 can be retrieved and used elsewhere in the combined system 1 (such as feedwater for steam generation) the overall water consumption of the plant is reduced and, in some cases, may turn the plant into a net water producing system.

Those skilled in the art will recognize that a wide range of conventional working fluids may be used in cooling system 1. One possibly preferred working fluid would be carbon dioxide (CO2). Those skilled in the art will recognize that with many conventional refrigerants, the working fluid leaving compressor 3 would be a liquid. However, with CO2, the state of the CO2 leaving the compressor may be supercritical. There may be cases where the working fluid leaving coil 7 may be a two-phase mixture, especially if CO2 is used as the working fluid, with very low moisture content. It will be recognized that by using CO2 as the refrigerant, the refrigerant is non-toxic and thus would pose fewer hazards than conventional refrigerants such as ammonia or the like to personnel if the system is well ventilated or located out of doors. Further, those skilled in the art that power plants of the future may well utilize carbon capture and utilization technologies such that a ready supply of CO2 may well be available for use with the refrigeration system of the present disclosure.

As an example of a direct expansion cooling system 1 of the present disclosure, the inlet air flow to a gas turbine may, for example, range from about 100,000-about 9,000,000 pounds of air/hour. This range may vary considerably, depending on the actual system. For example, if a gas turbine is operated at its base load, it may output about 800,000 pounds of exhaust gas/hour at about 890° F. It will be appreciated the cooling system 1 of the present disclosure may be utilized when the ambient temperature is above about 80° F. up to about 110° F. with relative humidity (RH) levels ranging between about 60%-18% at the extremes. Under these operating conditions, the net power consumption of cooling system 1 will range from about 2 MW-3 MW. Without the cooling system 1 operating, the gas turbine electrical generator output will decrease linearly from about 32.8 MW at 80° F. to about 25.7 MW at 110° F. With the cooling system 1 of the present disclosure operating so as to supply intake air to the gas turbine at constant 68° F. when the ambient temperature ranges, for example, between about 80° F. and about 110° F., the gas turbine electrical generator power output remains relatively constant at about 34.8 MW. Thus, under such ambient conditions, the use of the system of the present disclosure may in a power gain for the gas turbine ranging between about 4%-about 26%, where the power gain is linear with respect to increases in ambient temperature between about 80° F. and about 110° F.

Examples of the performance of the direct expansion cooling system 1 of the present disclosure with the gas turbine operating at its nominal base load at different ambient temperatures and relative humidity conditions are as follows:
At ambient conditions of 80° F., 60% RH, and a Dew Point of 65° F., the cooling coil 7 heat transfer will be about 635 BTU/second, and the condensate flow from coil 7 will be about 0 thousand pounds per hour (KPPH).
At ambient conditions of 100° F., 42% RH, and a dew point of 73° F., the cooling coil heat transfer will be about 2445.4 BTU/second and the cooling coil heat transfer in the condensing section will be about 995 BTU/second, and the condensate flow from the coil will be about 2.527 KPPH.
At ambient conditions of 110° F., 18% RH, and a dew point of 57° F., the cooling coil total heat transfer will be about 2220 BTU/seconds, and the condensate flow from the coil will be about 0 KPPH.

With the direct expansion cooling system 1 of the present disclosure operating to supply inlet air to the gas turbine at a constant temperature of 68° F., the gross power output of the gas turbine will remain substantially constant as the ambient temperature varies between about 80° F. and about 110° F. Thus, if the inlet air supplied to the gas turbine is 68° F. while the ambient temperature is about 100° F., the gas turbine gross power output will remain at about 34.8 MW such that a power savings of up to about 6.5 MW is realized.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

1. A system for cooling ambient air to be supplied as combustion air to a gas turbine comprising a closed coolant loop direct expansion cooling system, said coolant loop having a compressor configured to compress a suitable working fluid, an expansion device downstream from said compressor configured to expand the working fluid so as to cool a cooling coil, said cooling coil being configured to be in heat exchange relation with ambient air flowing to said gas turbine for lowering the temperature of the ambient air supplied to said gas turbine such that combustion air is delivered to said gas turbine at a temperature below said ambient temperature thereby to increase the efficiency of said gas turbine, and a return line for returning the working fluid to said compressor.

2. A system as set forth in claim 1 further comprising a heat exchanger configured to be in said closed system loop between said compressor and said expansion device for transferring at least a portion of the heat compression of said working fluid generated in said compressor to another heat exchange fluid.

3. A system as set forth in claim 1 wherein said working fluid is carbon dioxide (CO2).

4. A system as set forth in claim 3 where in the carbon dioxide working fluid may supercritical in portions of the cooling loop.

5. A system as set forth in claim 1 wherein said expansion device is an expansion valve.

6. A system as set forth in claim 1 wherein said expansion device is a turbine configured to extract work from said working fluid during the expansion phase.

7. A system as set forth in claim 5 wherein the last-said turbine is configured to generate electrical power for powering at least a portion of said cooling system.

8. A system as set forth in claim 1 further comprising a control configured to prevent the formation of ice on said cooling coil as said working fluid expands within said cooling coil.

9. A system as set forth in claim 8 wherein a control system is provided that is configured to substantially prevent the buildup of ice on said cooling coil.

10. A system as set forth in claim 6 wherein in operation moisture from said ambient air condenses on said cooling coil and wherein such condensed moisture is drained from the system as condensate.

11. A system as set forth in claim 10 wherein said system is configured to use said condensate to generate steam for said steam turbine.

12. A method of cooling ambient air to a desired temperature when ambient air is above said desired temperature so as to maintain the output of a gas turbine at substantially a constant output as the ambient temperature increases above said desired temperature, said method comprising the steps of:
a. Providing a closed loop direct expansion cooling system for cooling ambient air to be supplied to a gas turbine as combustion air to a desired temperature;
b. Compressing a working fluid to a relatively high pressure;
c. Expanding said working fluid through an expansion device;
d. Flowing said expanded working fluid through a cooling coil that is in direct heat transfer relation with the ambient temperature air flowing to said gas turbine so as to cool said ambient air to a desired temperature;
e. Returning said working fluid to said compressor to repeat the cycle.

13. The method of claim 12 wherein said step of expanding said working fluid is performed in an expansion valve upstream of said cooling coil.

14. The method of claim 12 wherein said step of expanding said working fluid is performed in a turbine, where the output of this last-said turbine may be used to at least in part power portions of said method.
